(19) United States
(12) Patent Application Publication
(10) Pub. No.: US 2017/0109690 A1
(43) Pub. Date: Apr. 20, 2017

(54) SUPERVISED SUPPLY NETWORK WITH COMPUTED INTEGRITY RATINGS AND CERTIFICATIONS

(71) Applicant: SCR Technologies, Inc., Ridgway, CO (US)

(72) Inventor: Randal B. Fischer, Ridgway, CO (US)

(73) Assignee: SCR Technologies, Inc., Ridgway, CO (US)

(21) Appl. No.: 15/337,024

(22) Filed: Oct. 28, 2016

Related U.S. Application Data
(63) Continuation of application No. 13/841,398, filed on Mar. 15, 2013, now abandoned.
(60) Provisional application No. 61/692,041, filed on Aug. 22, 2012.
(60) Provisional application No. 61/662,774, filed on Jun. 21, 2012.
(60) Provisional application No. 61/641,162, filed on May 1, 2012.
(60) Provisional application No. 61/619,752, filed on Apr. 3, 2012.

(51) Int. Cl. G06Q 10/08; G06F 17/30

(52) U.S. Cl. CPC G06Q 10/087; G06F 17/30958

(57) ABSTRACT

Embodiments of the present disclosure relate to constructing an Object Analytic Record (OAR) that may be used to store data from one or more sequential chains. Analytics may be performed on data in the OAR to generate ratings for one or more components of a supply chain or the supply chain itself. Analytics may also be performed on the OAR to provide a certification for a supply chain or for a supply chain components and products.

### PRIORITY AND CROSS REFERENCE TO RELATED APPLICATIONS

This application claims priority to: U.S. Provisional Patent Application No. 61/692,041, entitled “Interoperation of Supply Chain Registry Object Analytical Record with External Systems,” filed on Aug. 22, 2012; U.S. Provisional Patent Application No. 61/662,774, entitled “Chain and Product Certification Systems and Methods for Sequential Chain Registries,” filed Jun. 21, 2012; U.S. Provisional Patent Application No. 61/641,162, entitled “Chain and Product ratings System and Method for Sequential Chain Registries,” filed on May 1, 2012; U.S. Provisional Patent Application No. 61/619,752, entitled, “Chain and Product ratings System and Method for Sequential Chain Registry,” filed Apr. 3, 2012; All of the above identified applications are herein incorporated by reference in their entirety.

This application is related to U.S. patent application Ser. No. 13/218,288, entitled “Sequential Chain Registry,” filed on Aug. 25, 2011, which claims priority to U.S. Provisional Patent Application No. 61/377,809, entitled “Sequential Chain Registry System and Method,” filed on Aug. 27, 2010; and U.S. patent application Ser. No. 13/218,319, entitled “Event Chain Registry,” filed on Aug. 25, 2011, which claims priority to U.S. Provisional Patent Application No. 61/377,809, entitled “Sequential Chain Registry System and Method,” filed on Aug. 27, 2010, both of which are herein incorporated by reference in their entirety.

### BACKGROUND

It is often desirable to track an object as it traverses a sequential chain. For example, a consumer product begins as raw materials, which are then transported to a manufacturer that constructs a component of the consumer product using the raw materials. The component may then be transported to another manufacturer who constructs the consumer product using the component. The consumer product may then pass through any number of distributors until it reaches a retailer and, finally, the end consumer.

Because a consumer product, and the components and raw materials that make up the product, generally pass through so many different manufacturers that are often not organizationally related, it is difficult to track the product and its components as they travel through a supply chain or other form of sequential chain. It is even more difficult to track materials to which a barcode, RFID, or other extant form of tracking mechanism cannot continuously be physically attached to, and retained by, materials, as materials transit supply or other forms of chains. However, information related to products, components and raw materials is often desirable to consumers (for example, consumers who may be interested in tracking the origins and other attributes of products they purchase), to regulators (for example, regulators who may want to ensure that the materials used to make the products are used legally), and to other stakeholders. It is with respect to this general environment that embodiments of the present disclosure have been contemplated.

### SUMMARY

In embodiments, an Object Analytical Record (OAR) may be utilized to capture and bind data related to a sequential chain, such as, but not limited to, a supply chain or an event chain. For example, a sequential chain registry may be used to capture and bind data related to a product or object traversing a sequential chain. In other embodiments, the sequential chain registry may be used to capture and bind data related to an event over a sequence of time. The data may be captured and bound using the various sequential chain components. For example, systems and methods disclosed herein may employ Vertical Logical Conjunction to enable the capture of information when and where the data exists in a component of a sequential chain. This data may be part of a real-world economy network (e.g., a supply chain) or another type of network. Horizontal Logical Conjunction may then be employed to bind the information through time and space for supply chain components that are part of the supply chain. As such, the embodiments of SCR systems and methods disclosed herein may be used to capture and bind data from a network. Such data may be stored in one or more OARs. Furthermore, in embodiments, the OARs may be filtered according to search terms representing properties, text, or any other type of data stored in a sequential chain, such as data stored in a sequential chain component or other components of sequential chains disclosed herein. As such, OARs may be used to efficiently access captured and bound data for any type of network represented by a sequential chain.

Additional embodiments disclosed herein relate to rating a sequential chain or any of the components of a sequential chain (e.g., SCCs, SCCHEs, object, etc.). In embodiments, the systems and methods disclosed herein may generate one or more ratings for a sequential chain, or for a component of a sequential chain based upon information stored in the sequential chain. For example, information from the sequential chain may be used as input to a ratings function to generate a ratings score. The ratings score can be a standalone score (e.g., a score for a single SCC of an SC) or may be influenced by, or a function of, ratings of other components in the SC. For example, the score for an SC, or for an individual component of the SC, may be weighted based upon the scores of other components in the SC. In embodiments that will be described in further detail below, the data stored in an OAR may be used as input to one or more ratings functions to produce one or more ratings.

In further embodiments, a certification may be generated for an SC or for one or more components of the SC. In one embodiment, the certification may be based upon rating(s) or ratings score(s) generated for the SC or for individual components of the SC; however, in other embodiments, the certification may be based off of different criteria from the ratings. As such, a certification may be provided even if ratings do not exist for a particular SC or SCC. In embodiments, data stored in an OAR may be provided to one or more functions in order to generate a certification.

This summary, and including with respect to prior referenced applications, is provided to introduce a selection of concepts in a simplified form that are further described below in the Detailed Description, below. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 is an illustration showing exemplary relationships amongst Sequential Chain (SC), Sequential Chain Component (SCC), trade document (TD), Short Form ID for DocString Identifier and DocString Identifier objects.

FIG. 2 is an illustration showing exemplary relationships of material (e.g. instances of a product, raw material, thing, etc.) to Sequential Chain (SC), Sequential Chain Component (SCC), trade document (TD), Short Form ID for DocString Identifier and DocString Identifier objects.

FIG. 3 provides an illustration of an embodiment of a relational structure for the construct of Vertical Logical Conjunction, or VLC, a construct based on the transitive relation of the mathematics.

FIG. 4 provides an illustration of an embodiment of a relational structure for the construct of Horizontal Logical Conjunction, or HLC, a construct based on the transitive relation of the mathematics and which enables binding of data previously bound via the VLC construct.

FIG. 5 illustrates an example of constructing one or more OARs based upon data from one or more sequential chains.

FIG. 6 is an embodiment of a method 600 for performing data analytics using an OAR.

FIG. 7 is a flowchart illustrating an embodiment of method 700 for making an OAR accessible to an external system.

FIG. 8 is a flow chart illustrating a method 800 for computing ratings for various different components or objects in a supply chain.

FIG. 9 is an embodiment of a method 900 for providing a certification for a sequential chain and/or various sequential chain components.

FIG. 10 illustrates an embodiment of a computing environment 1000 such as that in which embodiments, running in an SCR system, may operate.

FIG. 11 illustrates an embodiment of a network environment 1100 in which embodiments, running in an SCR system, may operate including operation in a semantic web environment.

### DETAILED DESCRIPTION

Embodiments described herein relate to the creation of an Object Analytical Record (OAR) that may be used to capture and bind data related to a sequential chain, such as, but not limited to, a supply chain or an event chain. The OARs may be used to relate, or bind, data together from disparate systems as an object or an event traverses a sequential chain in space and/or time. The OAR may be used to link together information about a sequential chain and may be provided to other applications (e.g., an internal or external application or system to the system that constructed the OAR) to provide ready access to information about an object or event, as well as the sequential chain and its components. For example, information in an OAR may be used to link data regarding a supply chain and/or supply chain components with external data, such as data from government agencies, ratings agencies, international organizations, etc. Exemplary elements of a sequential chain include, but are not limited to, a sequential chain (SC), a sequential chain components (SCC), a sequential chain component host entity (SCCHE), and/or a Docstring Identifier that may be used to identify a relationship between the different components in a sequential chain. Further information on the construction of sequential chains and use of sequential chains to track objects and or events, along with information about objects, events and the like, is provided in related U.S. patent application Ser. No. 13/218,288, entitled “Sequential Chain Registry,” filed on Aug. 25, 2011; and U.S. patent application Ser. No. 13/218,319, entitled “Event Chain Registry,” filed on Aug. 25, 2011, both of which are hereby incorporated by reference in their entirety.

Additional embodiments disclosed herein relate to generating a rating for a sequential chain or any of the components of a sequential chain (e.g., SCCs, SCCHEs, object, etc.). In embodiments, the systems and methods disclosed herein may generate one or more ratings for a sequential chain, or for an element of a sequential chain based upon information stored in the sequential chain. For example, information from the sequential chain may be used as input to a ratings function to generate a ratings score. The ratings score can be a standalone score (e.g., a score for a single SCC of an SC) or may be influenced by ratings of other components in the SC. For example, the score for an SC, or for an individual component of the SC, may be weighted based upon the scores of other components in the SC. In embodiments that will be described in further detail below, the data stored in an OAR may be used as input to one or more ratings functions to produce one or more ratings.

In further embodiments, a certification may be generated for an SC or for one or more components of the SC. In one embodiment, the certification may be based upon ratings generated for the SC or for individual components of the SC; however, in other embodiments, the certification may be based off of different criteria from the ratings. As such, a certification may be provided even if ratings do not exist for a particular SC or SCC. In embodiments, data stored in an OAR may be provided to one or more functions in order to generate a certification.

As in embodiments described herein, a “Sequential Chain Registry” (SCR) may be one or more sets of systems, methods, and/or apparatuses that enable suppliers, customers and other users of the systems and methods disclosed herein to preserve and access data created, or capable of being created, within both complex and simple sequential chains (whether sequential chains treating with products and other things, sequential chains treating with events, or sequential chains treating with both products and events). An SCR may also include the ability further to relate such data to other kinds of data that may help describe the milieu or surroundings in which may be contained SCCs, SCs and other elements.

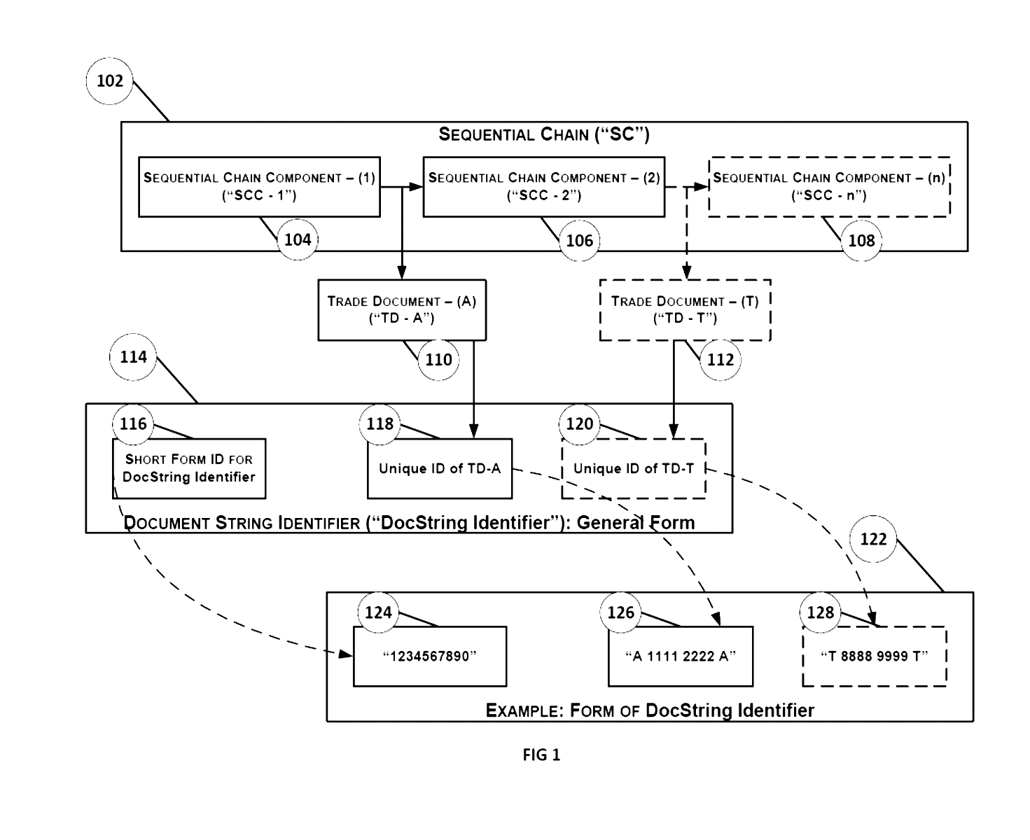

FIG. 1 is an illustration showing an embodiment of relationships amongst: a sequential chain (SC) 102 comprised of (n)-count of sequential chain components (SCCs) 104, 106, 108; trade documents (or other like forms of document, record, digital file, or other type of identifier, etc.) 110, 112 that may be used to record and establish the fact of some nature of traversal of a thing (like a product, object, widget or some material) from an SCC (n−1) to a next succeeding SCC (n); and the creation (in an embodiment of a Supply Chain Registry, e.g., in a prior referenced embodiment as described in the prior referenced applications) of a DocString Identifier 114, 122.

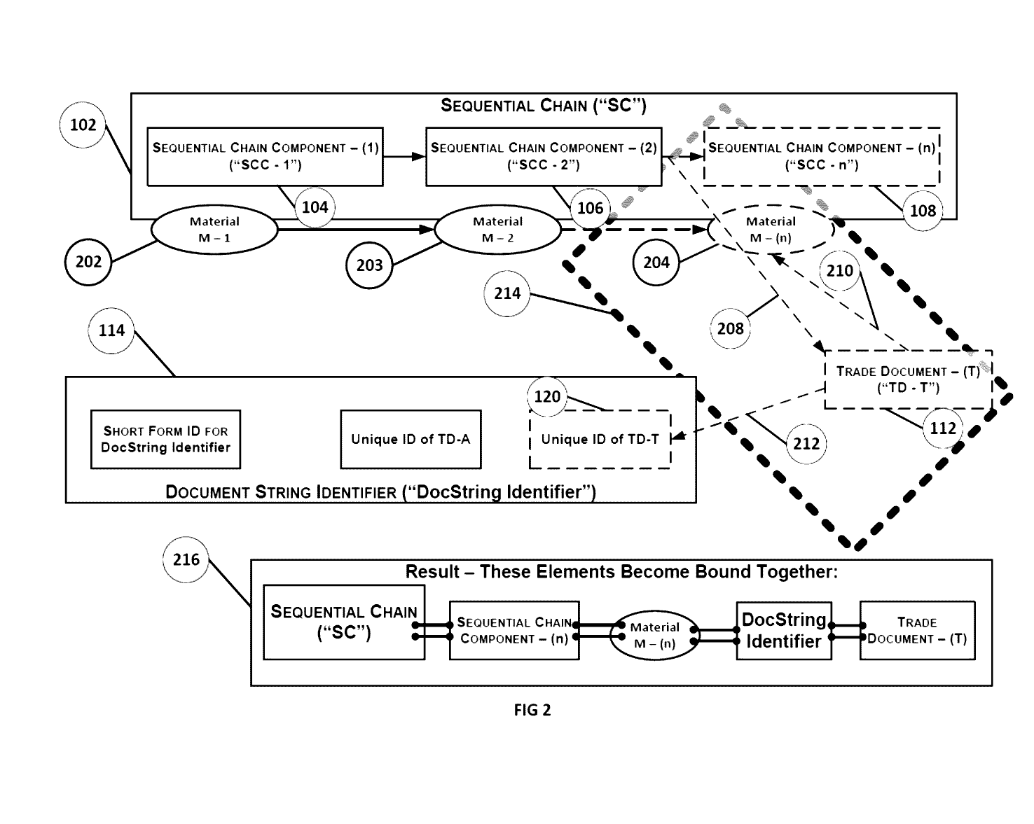

Still referring to FIG. 1, the object named trade document (also herein “TD”) may provide evidence of some nature of transaction or other event occurring or having occurred with respect to: a) an instance of product, material, object or other nature of thing (hereinafter, generically referred to as “material”) located at a point in time (or in an interval of time) in an SCC (n−1); and b) as the material instance then further relates to its being located at another time in the next succeeding SCC (n). For example: in FIG. 1, SCC-1 104 may represent an ocean tanker containing crude oil (as an instance of “material”); SCC-2 106 may be an onshore crude oil tank storage operation or business or simply a uniquely identified steel storage tank; and trade document TD-A 110 may be a bill of lading that gives evidence, possibly along with other information, of some nature of transaction that is, or was, conducted between the parties engaged with the two named SCCs 104, 106. The exemplary bill of lading in this instance, TD-A 110, therefore, in addition to having its normally intended purpose (e.g. to record particular information about the transaction and/or the physical movement of the instance of material, etc.) also may be used (since it already exists, in this example) in an embodiment of a Sequential Chain Registry not only to give object unique identity to the instance of material but also to identify facts concerning the relationship of the Material to both of the two SCCs 104, 106 from which, and to which, respectively, the material traverses. Of course, the instance of material may also have another form of object unique identifier (such as a unique, sequentially assigned integer or any other type of unique identifier). The utility of using an element such as an instance of trade document will become more evident as further description is next provided regarding how a set of such trade documents may be used to create an instance of a unique DocString Identifier. Such utility, then, will be further discussed later in discussing FIG. 2, which further introduces the construct of “material” (e.g., things, objects, raw and intermediate materials, products, widgets and the like) and instances of material as such instances traverse a sequential chain. While specific examples of materials and supply chains have been described herein, one of skill in the art will appreciate information about other types of materials or supply chains may be employed with the embodiments disclosed herein. Furthermore, while specific examples of trade documents have been provided, these examples are for illustration only. One of skill in the art will appreciate that any type of identifier, whether a document containing an identifier or another form of identifier, may be employed to construct the DocString Identifier without departing from the scope of the present disclosure.

Still referring to FIG. 1, multiple different instances and/or kinds of trade document (which may involve multiple different enterprises or parties, which may be mutually engaged throughout a sequential chain operation and even including a larger notion of a sequential chain network, for instance, different commercial buyers and sellers) may be employed, as described above, inter alia, to give evidence of the fact of a transaction being conducted between each succeeding binary set (pair) of SCCs. FIG. 1 depicts one exemplary transaction between parties engaged with SCC-1 104 and SCC-2 106 and another transaction between parties engaged with SCC-2 106 and SCC-n 108, where here ‘n’ represents an integer identifier for the ordinal-rank position of a particular SCC that next follows (in temporal and/or spatial context) the preceding SCC.

Corresponding to the two exemplary transactions just noted, there are shown in FIG. 1 the two respective exemplary trade documents, TD-A 110 and TD-T 112. As will be apparent to an artisan of ordinary skill, an instance of a trade document—such as a bill of lading, a customs form, an invoice, a demurrage report, an identifier, and the like—typically has assigned to it some form of unique identifier, e.g. a form of identifier for the instance of trade document itself. Such unique identifier may be a form of identifier that is locally defined within a singular enterprise; or it may be such form as may be created in a more global domain such as a particular economic sector or industry like the oil and gas industry; or it may be such form of another nature or domain, for instance, a Global Document Type Identifier (or GDTI) as managed by the GS1 organization (www.gs1.org). As will be apparent to an artisan of ordinary skill: when some form of identifier may not already exist for a particular trade document or may have existed but become lost or unavailable, an identifier may simply be created (for instance, by a system or method disclosed herein, a user, a device, or a party) and then associated with the trade document; and when a trade document itself may not already exist or may not be otherwise available, such trade document may simply be created (for example, by a system or method disclosed herein) in order to bind (in an system, method, or apparatus in which embodiments operate) appropriate data pertaining to an instance of material to one or more SCCs with which the instance may be associated.

Still referring to FIG. 1, once a temporally- and/or spatially-ordered sequence of instances of trade document (such as TD-A 110 next followed by TD-T 112) has been established within (for example, by or in conjunction with) an embodiment of a Sequential Chain Registry (e.g., in a system or method disclosed herein)—and with each such instance of trade document having its own document unique identifier 118, 120—then a logical/mathematical set of such unique document identifiers may be used to create an instance of DocString Identifier 114. More detailed descriptions of the construct of DocString Identifier, its purpose, its construction and its relational structure vis-à-vis other entities or elements in an SCR system are provided in the prior referenced disclosures.

In alternate embodiments, a DocString Identifier may be an integer string or an alphanumeric string of concatenated data elements, wherein each such element may be a unique document identifier string (like a GDTI or simply a unique sequential number) or other types of identifiers that apply to each member of the set of trade documents, that is, in the example shown in FIG. 1, to each of the set of instances of trade document TD-A 110 through and including TD-T 112. Again, one of skill in the art will appreciate that a trade document may be any form of identification for a material, a supply chain component, a supply chain component host entity, an object, or any other component or element of supply chain.

Referring again to FIG. 1, an example of an instance of DocString Identifier 122, wherein two exemplary alphanumeric strings 126, 128 are concatenated, thereby forming the DocString Identifier. In this example of DocString Identifier 122, the concatenated data object would become: [A 1111 2222 A]∩[T 8888 9999 T]. The concatenation operation itself may be performed by many different types of data manipulation tools—for instance, within a spreadsheet software tool or via query operations employed in semantic web applications and/or in relational database systems or any other type of computing system, application, or device—which may be used in interoperation with an instance of an SCR system. Furthermore, such concatenation operation, as just described, may be performed in a variety of temporal sequences or methods, for instance and by way of non-limiting example, may be performed: in real or near-real time whereby the concatenation is successively computed and the accreting, concatenated result may be permanently stored; or whereby discrete sub-parts of such concatenation operation may be permanently or temporarily stored and called out when needed; or in any other way known to the art. Different users may have different considerations and constraints regarding things like data storage cost or storage availability, or simply just different access and data-retrieval needs, such that many ways for performing such concatenation operation when constructing, or calling up, a DocString Identifier 122 may be used whilst still remaining congruent with the purposes of the DocString Identifier element.

In further embodiments, a short form of unique identifier 116, illustrated in FIG. 1, may be assigned to an instance of DocString Identifier 114. An example of such short form of identifier, used to provide object unique identification to an instance of DocString Identifier 122 itself, is shown in FIG. 1 as the exemplary data string, “1234567890” 124. As just described in the preceding paragraph, one use of the short form of identifier may be in the concatenation operation itself, whereby an instance of the short form of identifier may serve as a pointer for use in forming the full, concatenated form of DocString Identifier 122 “on call,” as needed, and where the latter 122 may include the short form of identifier 124 itself. In some instances of embodiments, such use of the short form of identifier may have benefits in data retrieval speed or data storage costs or other factors.

As such, instance of DocString Identifier may possess its own particular short form of object unique identifier, useful for example, as a matter of convenience, and the instance may also possess a long form of object unique identifier, that is, in the form of a set of concatenated unique trade document identifiers.

FIG. 2 illustrates a manner in which instances of a material object 202, 203, 204 (e.g., any type of object that traverses a sequential chain) may be logically related in embodiments disclosed herein to an instance of supply chain (SC) 102 and to instances of supply chain components (SCCs) 104, 106, 108 (as a set of SCCs may comprise a particular SC) in which the material may traverse from a particular origin to some other particular destination, for example, by way of intermediate points. As such, elements 102, 104, 106, 108, 202, 203, 204 in FIG. 2 may represent both temporal and spatial flows of instances of material through a sequential chain such as a supply chain. As earlier described herein and in conjunction with FIG. 1, the constructs of DocString Identifier 114 and trade document (or TD) 112 (and an instance of a unique identifier that may be assigned to a TD or other form, object, etc.) may be used to achieving a binding amongst a plurality of data elements for instances of all of: material; SC; SCCs (comprising an SC); and their corresponding instances of identifiers.

Extending from the object relationships described with FIG. 1, a still larger set of entity relationships is depicted by the dashed box 214 shown in FIG. 2. Illustrated in this box 214 is the set of binary relationships amongst: a) an instance of material M-(n) 204 (meaning here a material instance located in an SCC holding position (n) in an instance of an SC 102); b) preceding instances of material M-1 202, M-2 203, etc.; c) trade document TD-T 112 (which, as earlier described, may possess its own object unique identifier, shown as object 120 with binding 212), which binds 210 to material M-n 204 and also binds 208 to both SCC-n 108 and to the SCC-2 106 preceding that SCC-n 108.

Still referring to FIG. 2, similar data bindings for other instances of material 202, 203, 204 (e.g., an object in a supply chain) may be created for each object set (in a particular SC 102) comprised of an instance, for example, in each of: an SCC; a material in the SCC; and a trade document (“TD”), which TD aids to identify the material in the SCC via a TD-identifier. In turn, then, an instance of DocString Identifier 114 may serve to bind data together for all such data sub-bindings just described.

The illustrative object 216 illustrated in FIG. 2 portrays an exemplary representation of a result of binding together (via operations of an instance of an SCR system), for a particular instance of SC: targeted data for all instances of SCCs comprising the SC; targeted data for all instances (and corresponding physical and chemical forms) of material that traverse the SCC via the set of SCCs, including such material instances as these may be modified as a result of traversal of the SC (for example, crude oil may be modified both in its geo-location and by processes like distillation and cracking in a petroleum refinery as the crude oil traverses the SC); targeted data for all instances of TDs (with their corresponding, respective TD-identifiers); and an instance of DocString Identifier. The DocString Identifier 114 construct (as shown in both FIGS. 1 and 2) enables this form of deeply connected, linked data from multiple different sources (and including distributed data sources), in particular in reference to instances of material wherein the material or thing is an “uncovered object,” e.g., an instance of object type not capable of continuously (through a supply chain) holding an extant form of object unique identifier like an RFID or barcode.

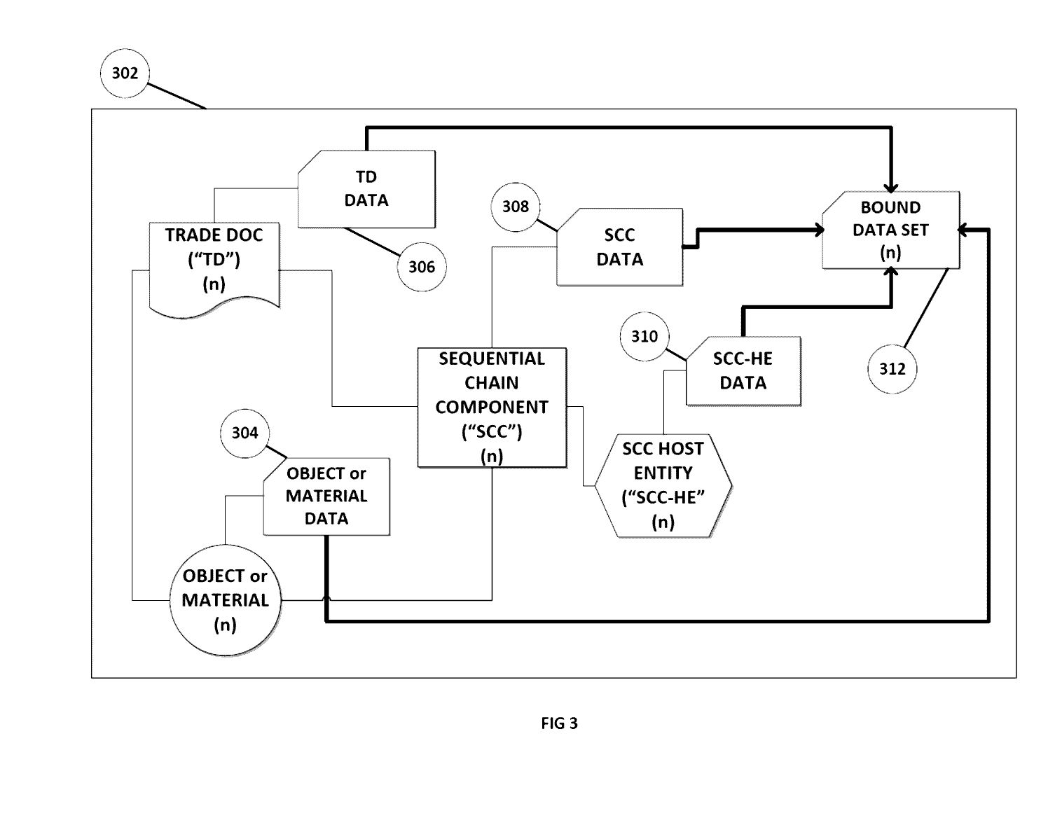

In embodiments, Vertical Logical Conjunction may be used to enable the capture of information when and where the data exists in a component of a sequential chain. This data may be part of a real-world economy network (e.g., a supply chain) or another type of network. FIG. 3 provides a representational illustration 302 of the construct herein referred to as Vertical Logical Conjunction, or “VLC,” which construct is more fully described in the prior referenced disclosures. By the VLC construct, a bound data set 312 may be formed, e.g., may be constructed in an SCR system, by joining relationally-connected data from multiple different sources (including from distributed data sources and sources that may involve data that is more or less dynamic in time or more or less static in time). Such source domain data may include data about instances of: i) material 304; ii) trade document 306; iii) SCC 308; and vi) SCC Host Entity 310.

In the illustration 302 of FIG. 3, the notation of “(n)” signifies the ordinal-rank position(n)—e.g., the first, second, third and so forth position or link in a sequential chain—in which a SCC exists (or existed) and in which an instance of material exists (or existed) and also whereby an instance of trade document may be used relationally to connect the instances of material and SCC. Thus, the bound data set 312 is understood to mean a set of multi-dimensional data—as such data set may be created in an SCR system from multiple different sources of data. A common feature of such data set is that of the data in the bound data set being related to all of instances of the Classes material, trade document and SCC as these instances pertain to a common Position “(n)” that the SCC holds with respect to multiple different such positions within a registered SC and, further, where data about the SCC Host Entity (including any hierarchical Host Entity structure sub-elements, as in Country→Zone→City→Precinct) relates to the SCC in Position “(n).” Thus, what one sees in observing an instance of a bound data set (n) 312 is a manifestation of one of the intended goals of an embodiment (operating in an SCR system), whereby desired target data relative to a singular Position “(n)” may be joined together and stored in an SCR system.

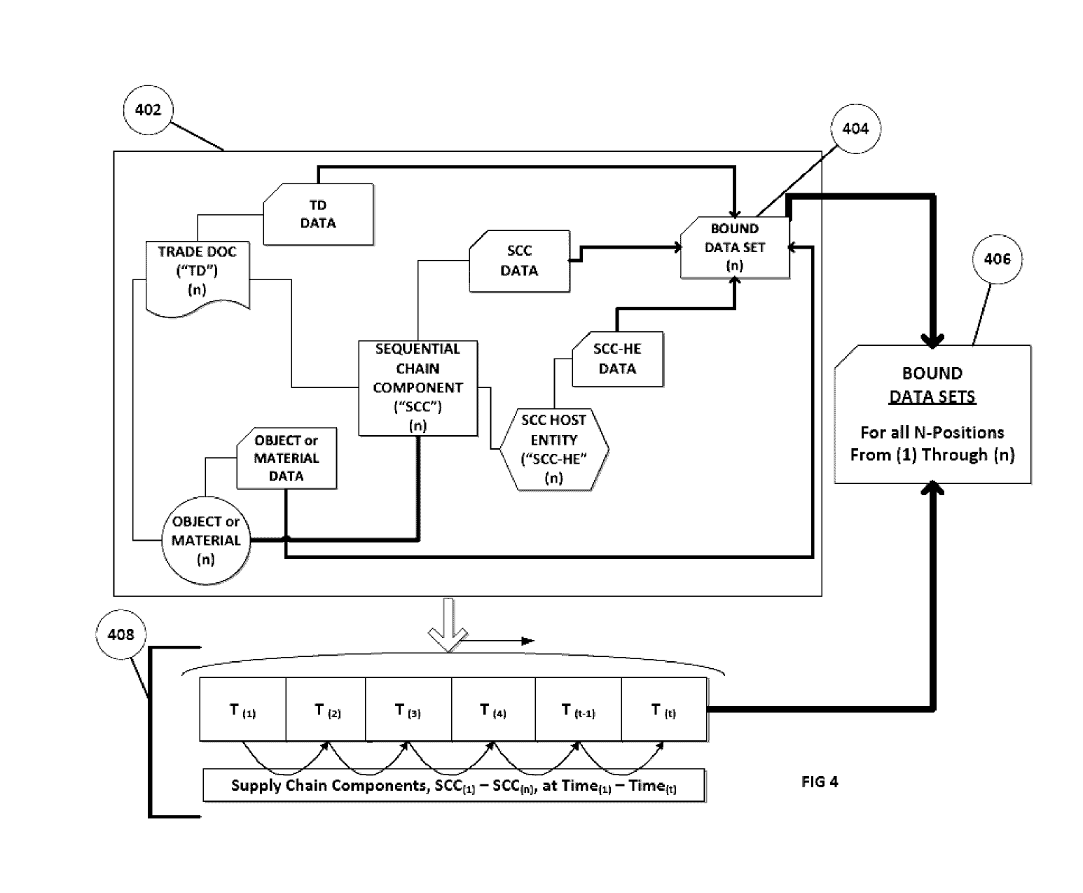

The following discussion with respect to FIG. 4, describes how such data-binding goal then may be extended to enable conjoining of such n-Position bound data set to encompass all n-count of Positions from a first to a last Position in a registered SC, comprised of multiple different (n)-count of registered SCCs.

Horizontal Logical Conjunction may then be employed to bind the information through time and space for supply chain components that are part of the supply chain. FIG. 4 includes a representation 402 of multiple different data source domains employed—e.g., relative to a particular SCC Position-n—which may comprise a data target domain 404 of a bound data set relative to the particular Position-n. That is, the representational bound data set 404 is understood to mean the data target domain that satisfies a target goal constraint for forming such relational data set comprised of the several data source domains included in object 402.

Also shown in FIG. 4 in object 406, which object represents a larger set of bound data that may be formed for embodiments (operating in an SCR system), whereby the larger set 406 may be comprised of data subsets such as the bound data set 404 that relates to a singular Position-n of a particular SC comprised of multiple different SCCs. A representation of a time-related process for forming such larger bound data set 406 is that shown with object 408 in FIG. 4. Representation 408 represents that a plurality of bound data sets like data set 404 may be generated by operation of embodiments (running in an SCR system), whereby each such data set for all Positions “n” in a Sequential Chain (SC)—as represented by the time-flow element in representation 408—may be formed, thereby generating the larger bound data set 406 comprised of all Position-n-specific data sets 404 for integer values of “n” from (1) to (N).

What the bound data set 406 in FIG. 4 represents, therefore, is a bound data set comprised of all SCC Position-specific data sets, such as the exemplary data set 312 shown in FIG. 3, which may comprise multiple different positions within a registered SC that, itself, is comprised of multiple different SCCs. The bound data set 406 in FIG. 4, therefore, exemplarily represents the objective goal for embodiments operating in an SCR system as pertaining to processes for accessing, capturing, relating, storing and otherwise managing such deeply-chained data for instances of all of: material, SCC, SCC Host Entity, SC and any other desired target data. Once such deeply-chained data has been created for embodiments operating in an SCR system, it then is possible for system users, stakeholders and others to access such bound data—pertaining to the life of the material instance as it traverses (or has traversed) a Sequential Chain—and to view such data, as a function of query operations, for instance by using the SPARQL query language as such may be employed in an SCR system operating in a semantic web environment.

Generating and Utilizing an Object Analytic Record (OAR)

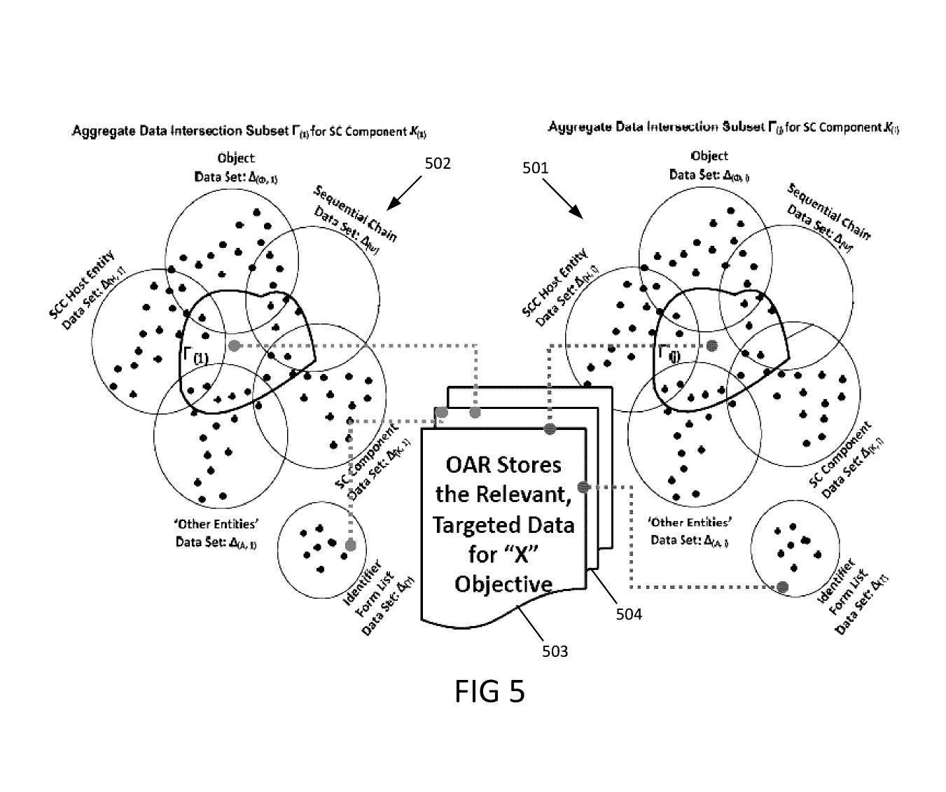

Having provided detail about the construction and relationships of sequential chains, the disclosure now turns to the creation and use of an Object Analytic Record (OAR) to provide access to data in a sequential chain. Because data stored in an SC and the multiple components across the SC may be in many different formats and/or may require use of many different communication protocols to access, due to the fact that SC data may reside in multiple different enterprise systems, standardizing the data may be used to aggregate the data from an SC into a standard form in an OAR. As such, the OAR may provide data from a SC in a format that is easily accessible and modifiable. In embodiments, OARs may be employed to store data aggregated in a sequential chain. As such, an OAR may be an aggregation of the data stored in an SC, that is, an OAR may contain data from the various SCCs, SCC Host Entities, and objects that are related in a SC. The OAR provides a mechanism by which applications may access the data in an SC for querying and analytical purposes. FIG. 5 illustrates an example of constructing one or more OARs based upon data from one or more sequential chains. As illustrated in FIG. 5, a first aggregate data subset 501 from a first sequential chain and a second aggregate data subset 502 from a sequential chain can be determined. In one embodiment, the first and second aggregate data subsets 501 and 502 may be from the same sequential chain. In another embodiment, the first and second aggregate data subsets 501 and 502 may be from different sequential chains. In embodiments, the aggregate data sets 501 and 502 may contain data from a sequential chain, an object, a sequential chain component, a sequential chain component host entity, or other entities that are part of the data set. Data from the aggregate data subsets 501 and 502 may be used to create one or more OARs, such as OARs 503 and 504, respectively. In embodiments, the data aggregated in an OAR may be used to produce a rating, a certification, or as a means to provide sequential chain data to external systems.

One advantage such aggregated data in an OAR is attributable to the interlinked, or bound, nature of the created data sets, whereby a consumer of such data output may realize useful, actionable knowledge and insights about the products and processes described by the data, knowledge and insights. Aggregated data, knowledge and insights may be used to provide views into the “Where and How” by which products and services are brought into the different market places of the world's economy. Such “Where and How” knowledge, in today's highly globalized economy may usefully be reflected upon as one central essence of the rapidly growing societal movements and initiatives for accessing more, and more reliable, knowledge about enterprises' operations and conduct in the economy.

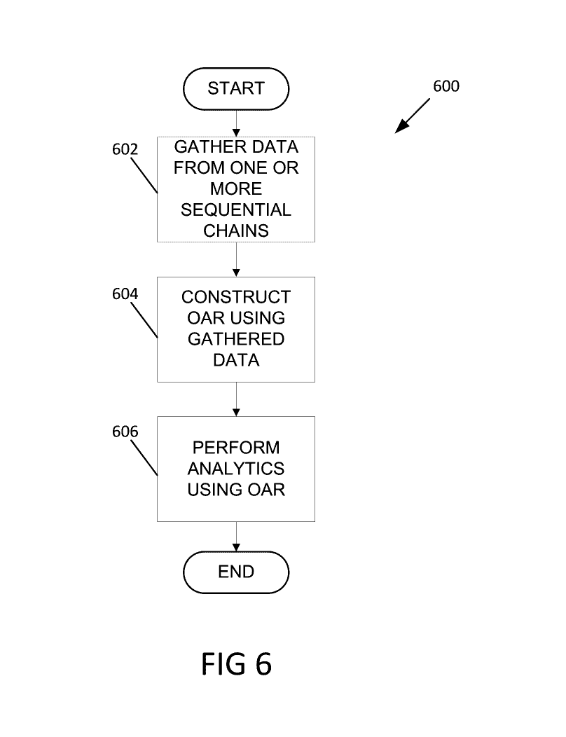

FIG. 6 is an embodiment of a method 600 for performing data analytics using an OAR. Flow begins at operation 602 where data may be gathered from one or more sequential chains. In embodiments, gathering data from a sequential chain may include gathering all data from the sequential chain and its components (e.g., SCCs, SCC Host Entities, objects, etc.). In alternate embodiments, gathering data from the sequential chain at operation 602 may be targeted, such that only specific data is gathered at operation 602, for instance, a data subset relevant to a particular analytical or other objective. For example, data related to a specific place, object, or item may be gathered from the sequential chain at operation 602 instead of all the information. Further, in embodiments, operation 602 may include gathering data about the sequential chain or about the SCC Host Entities that comprise the sequential chain, wherein such data may exist outside of the SC or SCCs and describe facts about those elements, for instance, data published by and accessible from the International Monetary Fund (IMF) or the United Nations (UN). In embodiments, the data gathered from (or about) the one or more sequential chains may be received by and stored in a database, on a local machine, on a remote machine, or may be stored in a distributed environment such as a cloud network.

Upon gathering the data at operation 602, flow continues to operation 604 where an OAR is constructed using the gathered data. In embodiments, the OAR may be used to aggregate data related to a specific item, target, or purpose. In one embodiment OAR may store the gathered data in a flat file, such as but not limited to an XML file, an HTML file, that may be used to quickly and easily access the information in the OAR. In another embodiment, the OAR may be stored as a database table in a database. In other embodiments, the OAR may be stored using a different format, for instance, in a triples database within a semantic web environment. One of skill in the art will appreciate that the format of the OAR may change depending on the use of the OAR or the capabilities of the system creating and/or storing the OAR.

Flow continues to operation 606 where the OAR may be used to perform data analytics. In one embodiment, data from an OAR may be used to generate a score. In another embodiment, the data from the OAR may be used to generate a ratings, such as but not limited to the component and product ratings described herein. In embodiments, information from the OAR may be used to generate ratings for a supply chain, a supply chain element (e.g., a SC, SCC Host Entity, etc.) or for a product or material as it traverses the supply chain. In still another embodiment, data from the OAR may be used to perform certification, such as the certifications described herein. In alternate embodiments, an OAR may be used to aggregate specific data. As such, using the OAR to perform data analytics may provide efficiencies with respect to accessing data by aggregating desired information for the analytics in a single structure, as opposed to requiring a requestor to retrieve desired information from a sequential chain and various sequential chain components, which may be spread across different enterprise systems in disparate formats and requiring disparate communication protocols. Aggregation of specific data into an OAR may also afford efficiencies at run time by segregating persistent data into an OAR.

In other embodiments, an OAR may be exposed to external system (e.g., systems that are not a part of the SCR systems described herein and in the prior referenced applications). In such embodiments, one or more OARs may be tailored such that they contain information from one or more sequential chains that are relevant to an external system. In one embodiment, one or more OARs may be created for data mining purposes and exposed to different third party systems. In another embodiment, information from one or more sequential chains may be aggregated in one or more OARs and made accessible to third parties. For example, an online retailer may decide to provide information about the origin of specific products it sells to its customers as a way of distinguishing the online retailer. As is described herein and in the prior referenced applications, the SCR systems and methods are particularly suited for tracking and maintaining such information. The information, for example as related to different products, stored in the SCR system may be aggregated into one or more OARs, which may be made accessible to the online retailer, thereby providing the online retailer with information needed to supply additional product information to its customers, out of which may be derived certain competitive advantages for the online retailer like comparative advantage by product differentiation. In other embodiments, the OARs may be accessed by recommender systems (e.g., systems that recommend products to users) to provide additional information that may be useful in determining whether a particular user would be interested in certain products. While specific examples of external systems have been provided herein, one of skill in the art will appreciate that OARs may be tailored, generated, and made accessible to any type of external system. Furthermore, while the OARs may be provided to external systems to perform certain functionality as described above, one of skill in the art will appreciate that it is not necessary that such functionality be provided by an external system. For example, the system generating the OAR from the data from a sequential chain (e.g., SC data, SCC data, SCCHE data, object data, etc.) may also implement a recommender system algorithm, a classifier algorithm, an online retail system, or any other system.

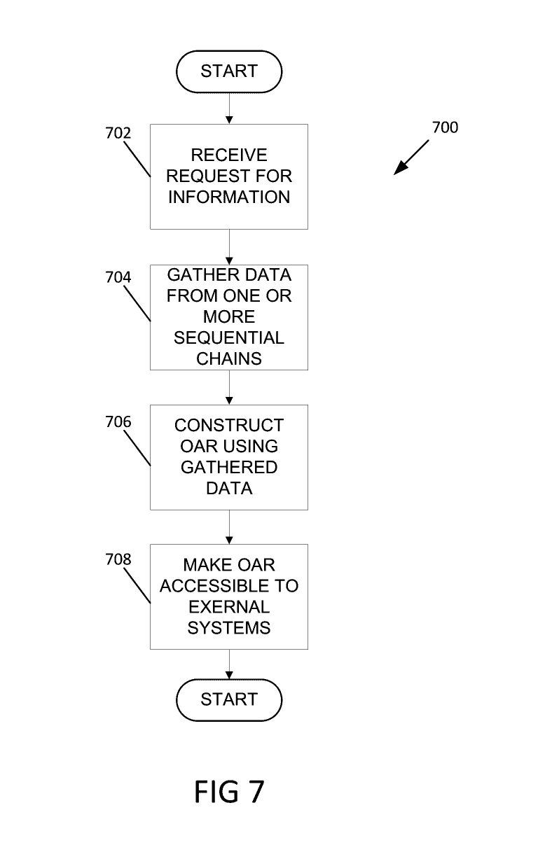

FIG. 7 is a flowchart illustrating an embodiment of method 700 for making an OAR accessible to an external system. Flow begins at operation 702 where a request is received for information stored in a sequential chain and/or one or more sequential chain components (e.g., objects, SCCs, SCC Host Entities, etc.). In embodiments, the request may be received in a message sent by an external application or system to an SCR system or an application that is part of the SCR system. In other embodiments, the request may be received from an external system interacting with an application program interface (API) that an SCR system exposes to external application. In such embodiment, the request for information may be transmitted via the API. In still further embodiments, the request may be automatically generated upon the modification of an SC, for example, by adding or modifying a SCC or SCC Host Entity. One of skill in the art will appreciate that any manner of requesting information may be employed to transmit the request received at operation 702.

Upon receiving the request, flow continues to operation 704 where data is gathered for one or more sequential chains. Gathering data may comprise marshaling data from a constructed SC in order to standardize the data. Because data stored in an SC and the multiple components across the SC may be in many different formats and/or may require use of many different communication protocols to access, due to the fact that SC data may reside in multiple different enterprise systems, standardizing the data may be used to aggregate the data from an SC into a standard form that may be accessed and/or queried. In embodiments, standardizing the data may comprise transforming data from the SC and one or more of the components of the SC into another form, e.g., an XML document, an HTML document, a relational or object database, etc. The format of the data may be specified by the request. In embodiments, gathering data from a sequential chain may include gathering all data from the sequential chain and its components (e.g., SCCs, SCC Host Entities, objects, etc.). In alternate embodiments, gathering data from the sequential chain may be targeted, such that only specific data is gathered. For example, data related to a specific place, object, or item may be gathered from the sequential chain instead of all the information. In such embodiments, the specific data may be identified by the request received at operation 702. In embodiments, the data gathered from the one or more sequential chains may be stored in a database, on a local machine, on a remote machine, or may be stored in a distributed environment such as a cloud network. In embodiments in which the data is stored remotely from the machine performing the method 700, a request may be sent specific data. In such embodiments, the data may be received in a message responding to the request for the data.

Upon gathering the data at operation 704, flow continues to operation 706 where an OAR is constructed using the gathered data. In embodiments, the OAR may be used to aggregate data related to a specific item, target, or purpose. In one embodiment OAR may store the gathered data in a flat file, such as but not limited to an XML file, that may be used to quickly and easily access the information in the OAR. In another embodiment, the OAR may be stored as a database table in a database. In other embodiments, the OAR may be stored using a different format. The OAR may be stored locally or on one or more remote machines. One of skill in the art will appreciate that the format of the OAR may change depending on the use of the OAR or the capabilities of the system creating the OAR. In embodiments, the request received at operation 702 may specify a format for the OAR. In such embodiments, the OAR may be formatted accordingly at operation 706. In embodiments, the request received at operation 702 also, or alternatively, may be format-agnostic, thus allowing for formatted information derived from the OAR to be returned with pre-formed formatting, for example, “default” formatting.

Flow continues to operation 708, where the OAR is made accessible to an external system. In one embodiment, the OAR created at operation 708 may be provided to the external system. For example, the OAR may be transmitted to the external system at operation 708. In another embodiment, the OAR may be stored in data storage that the external system has permission to access. In yet another embodiment, an API may be utilized to access information in the OAR. One of skill in the art will appreciate that other means of making the OAR accessible may be employed at operation 708.

By making the OAR accessible to external systems, such as third party systems, an OAR may be treated as enabling an information filter for the data stored in one or more sequential chains. As such, OARs may be utilized to readily provide access to data collected in the sequential chains stored in an SCR system. In embodiments, a user interface may be employed that allows users of the SCR system to select data to be included in an OAR. For example, referring back to FIG. 7, the request for information received at operation 702 may be provided via interaction with a user interface.

Generating Ratings for a Supply Chain Component and/or a Supply Chain.

Having discussed the different components that may make up a sequential chain and the use of an OAR to gather data from one or more sequential chains, the disclosure will now focus on the different types of analytical operations that may be performed using data from a sequential chain. Once such type of analytics relates to the generation of one or more ratings for one or more components or objects in a supply chain, or for an entire supply chain itself. Ratings may provide a score, or a judgment, on the quality of particular object or component or sequential chain. In embodiments, the ratings may be related to any aspect of a supply chain. For example, a particular element in the supply chain, such as, for example, a manufacturing company, may be rated on the quality of its products, whether or not it is an environmentally friendly operation, treatment of employees, or any other type of rating. As such, ratings provide a powerful tool that may be leveraged by companies to ensure that they are meeting desired standards, or company watchdogs to verify the claims a company makes with respect to environmental friendliness, employee treatment, use of sustainable materials, etc. For example, embodiments disclosed herein may be implemented by an enterprise, e.g. by an international oil company or by an external entity such as, for example, an industry association such as the American Petroleum Institute. In order to provide the relevant ratings to a variety of different groups or entities that may have divergent interests in a particular supply chain, different ratings metrics may be supplied by different users that may use information from the SC to generate ratings of interest to a particular user.

Different ratings metrics used in, with or by an SCR system for embodiments rating an SCC may, by way on non-limiting examples, pertain to metrics that describe, identify, characterize, delineate, distinguish or otherwise express any desired nature of, or feature about, an instance of Sequential Chain Component (SCC). For instance, one such metric pertaining to an instance of SCC may be an ownership-metric, e.g. one that signifies whether the SCC instance is owned or leased by the registrant (e.g., an identified company or operator in an SCR system) of the SCC. For instance, this exemplary ownership-related metric may be used to signify a type or quality of value judgment regarding ownership (for example, versus non-ownership such as by way of third-party leasing) by a registrant of a particular SCC in or with an SCR system. In further embodiments, ratings for a particular SCC may be used, in turn, as inputs to other ratings functions in order to generate ratings for an entire Sequential Chain (SC) comprised of multiple different SCCs. Furthermore, the ratings may be used as input to certification functions, described in more detail below, to provide certification for an object, a supply chain component, or an entire supply chain.

In embodiments, an entire SC comprised of multiple SCCs, whereby every SCC in the SC may not be owned (but rather, say, is leased) by the registrant of the SC, may be evaluated as one that entails a high degree of risk for the very reason of diminished control over any and all of the elements (components) comprising the entire SC. Information of such nature—whereby a high degree of data chaining (e.g., binding) is enabled by an SCR system to identify and characterize features of an SC that are derived from features of the constituents or components (SCCs) comprising the SC—may hold high interest to many different stakeholders engaged in some manner with the SC (or other like SCs).

Embodiments herein described, whereby any nature of rating may be constructed as pertaining to any or all of SCCs, SCC Host Entities, SCs and products (materials, objects, etc.) that traverse SCs vian SCCs and SCC Host Entities, may hold particular value to multiple different stakeholders in the global economy by virtue of the capabilities that may be designed into the ratings embodiments disclosed herein, and may represent many different sources and types of information, doing so via easy-to-comprehend, broadly-encompassing measures.

Generating ratings for a sequential chain may also provide opportunities and solutions for information optimization to groups that are interested in the same type of information, e.g., specific industries, non-profits, governments, etc. For example, the ratings generated in embodiments disclosed herein may signify a measure (relative or absolute) of overall “integrity” for a particular SCC that has been registered within an SCR system. Multiple different users, stakeholders, enterprises and others may find benefit in having access to such SCC ratings, for instance, as measures of transparency, risk, sustainability or whatever else may be captured in a composite, multi-property form of a rating. Additionally, enterprises that operate sequential chains (SCs) and/or components of sequential chains (SCCs) may derive benefit from information contained in embodiments by virtue of being able to make operational and other adjustments to improve such ratings in their SCCs (and in their SCs comprised of multiple different SCCs). Such changes or adjustments, therefore, may represent a type of information optimization, akin to cost optimization initiatives taken in conventional logistics operations. Such nature of information optimization may afford value to enterprises, as they consider ways to tailor their sequential chain operations (and logistics operations, more generally) to benefit from knowledge learned by operation of the ratings embodiments disclosed herein. Through such information optimization, it may even be feasible to obtain good cost estimates of the cost of certain information, whereby operational adjustments may be modeled to afford particular, targeted information results—e.g., to enable targeted changes in target data output results—which may be accompanied by changed cost metrics, for example when particular SCCs may be substituted for other SCCs (with, possibly, higher or even lower costs), thereby enabling improved control over an enterprise's desired information metrics.

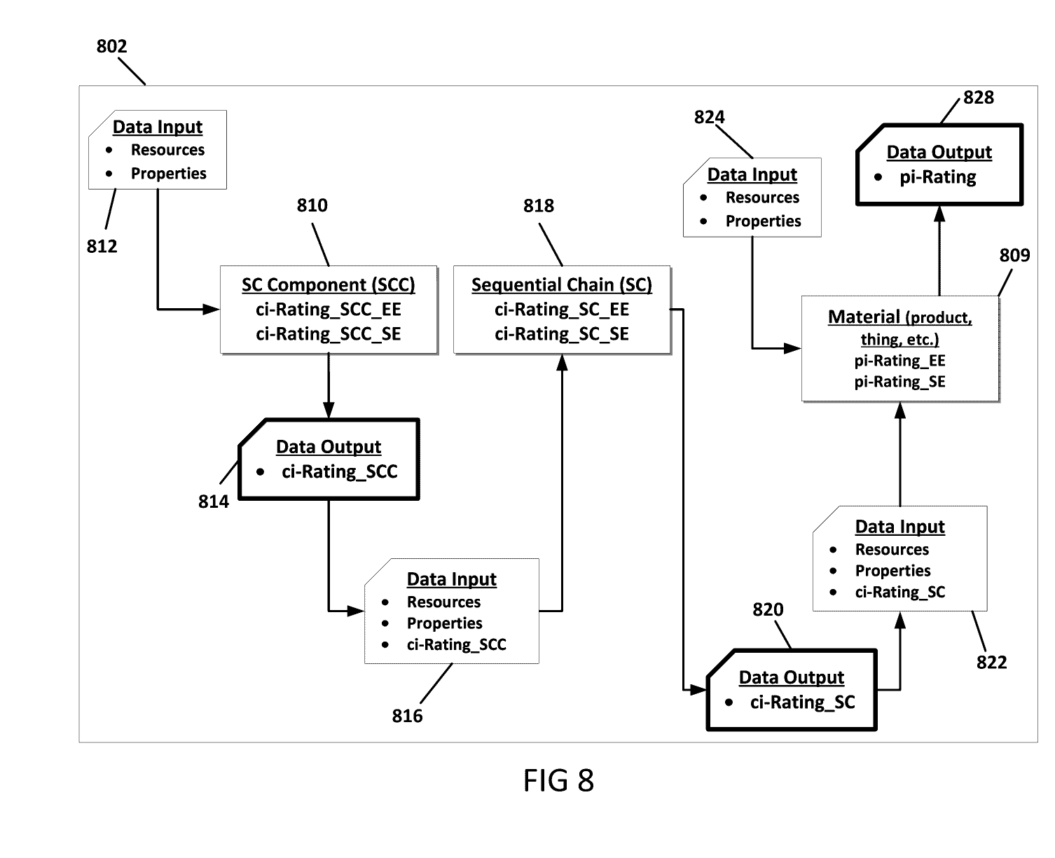

FIG. 8 is a flow chart illustrating computing ratings for various different components or objects in a sequential chain. In embodiments, ratings may be for an enterprise that is an element in a sequential chain (e.g., data from an SC, SCC, or SCC Host Entity) or about a product, object, or material that traverses a sequential chain. In embodiments described with respect to FIG. 8, entity ratings may be desired and the formulas may be defined by different parties, e.g., an enterprise entity (which may be the entity represented by an element in the sequential chain) itself or an external party. In the description accompanying FIG. 8, the ratings for an element in a sequential chain are referred to as “ci-Ratings.” Product, material, or object ratings are referred to as a “pi-Rating.” Ratings based upon a metric or formula provided by an enterprise entity is designated as an “Enterprise Entity” or “EE.” Ratings based upon a metric or formula provided by an external party is designated as a “Stakeholder Entity” or “SE.” However, as used throughout the disclosure, the term “rating” or “ratings” refers to either type of rating (e.g., ci-Ratings and pi-Ratings) which may be defined by an Enterprise Entity, a Stakeholder Entity, or any other type of entity.

In embodiments, Object 802 represents relationships with respect to embodiments of SCR system 804 (e.g., a system disclosed herein). As earlier herein described, ratings may take forms whereby an embodiment may entail having its properties set (e.g., specified or introduced into an application in which the embodiment is reified or instantiated) by: a) an Enterprise Entity or “EE”; and/or by b) a Stakeholder Entity “SE”, whereby is meant by the latter any nature of entity, person or other than an Enterprise Entity (for instance, a human customer or consumer). Embodiments herein disclosed include embodiments of rating for: i) ci-Rating_SCC 810, e.g., with respect to SCCs, both for property-specification by EE and by SE; ii) ci-Rating_SC 818, e.g., with respect to SCs, both for property-specification by EE and by SE; and iii) pi-Rating 809, e.g., with respect to instances of material, both for property-specification by EE and by SE.

As illustrated in FIG. 8, data input (e.g., a source domain) 812 into embodiments of ci-Rating_SCC 810 may include both “Resources” and “Properties.” In embodiments, Resources may include objects such as SCC, SC, a user or registrant, a material or object, SCC Host Entity (e.g., a country), etc.

Still referring to FIG. 8: After an embodiment of ci-Rating_SCC 810 becomes engaged with data input 812, computational operations may be performed as herein described (and, with respect to an SCR system), and therefrom data output (target domain) 814 may be produced. Such data output 814, in turn, may serve as a data input, e.g., as part of data input 816 that may be used in computing instances of embodiments of ci-Rating_SC 818. Thus, it is noted that data output for ci-Rating_SCC 814 may also be employed as data input for data input set 816.

In FIG. 8, data output 820, in form of values for instances of ci-Rating_SC 818 then becomes available for other uses, including for use in computing instances of embodiments of pi-Rating 809 as next described. It is noted that the data output for ci-Rating_SC 820 may also be employed as a data, e.g., data input set 822.

To this stage, then, data elements represented in FIG. 8 by data inputs 812, 816 and by data outputs 814, 820 may include data elements that have been described herein up through this paragraph and in FIGS. 1 through 8.

As further illustrated in FIG. 8, data output 820, which includes values of ci-Rating_SC (e.g., one or more rating for an entire SC, comprised of one or more different SCCs), becomes data input 822 for embodiments of pi-Rating 809, which embodiments pertain to instances of a material (e.g., products, things, objects, etc., which may have a tangible or an intangible form). In turn, then, data input 822 and other data input 824 (e.g., other data inputs related to materials, objects, products, or other elements) may become engaged with embodiments of pi-Rating 809, thereby used in generating data output 828 pertaining to pi-Rating 809, that is, pertaining to rating characterizations for instances of a material, product, object, etc.

By way on non-limiting summary, then, and with further reference to FIG. 8: Data output 814 for embodiments of ci-Rating_SCC may serve as data input 816 (potentially in addition to other data input, e.g. other elements, object, materials, etc. and any related properties) to embodiments of ci-Rating_SC 818, and data output 820 from the latter may then serve as data input 822 (potentially in addition to other data input, e.g. other elements, object, materials, etc. and any related properties) to embodiments of pi-Rating 809, which in turn may enable computation of data output 828 for pi-Rating. Such then is the overall data flow pattern whereby embodiments disclosed herein may be employed to compute values of rating for instances of any or all of SCC (data output 814), SC (data output 820) and material (data output 828).

The set of data outputs 814, 820, 828 (as illustrated in FIG. 8), thus, affords collective data output that may be created by the embodiments disclosed herein, thereby enabling delivery to enterprises, stakeholders and others of deeply-chained data pertaining to inter-connected data patterns for materials, products and other things that traverse sequential chains via SC components throughout the global economy. By enabling such deeply bound-together data—for virtually any tangible or intangible material or other thing in the global economy, society as a whole may realize benefits by being better able to understand not only the products purveyed but also the processes and the circumstances surrounding processes (e.g. the milieu data) by which products are placed into multiple different markets. Such deeply chained data, therefore, gets to the heart of modern society's growing interest in information often characterized by rubrics of transparency, sustainability, risk, environmentalism and the like. By enabling such deeply-chained data, new patterns of information may be created via embodiments (operating in an SCR system). From such new information patterns may emerge new knowledge about how products and things in the global economy are created and used and how they have impacts on and in society that may be largely unknown without the availability of embodiments of rating operating in an SCR system. Next is described in further detail how embodiments of pi-Rating—that is rating for material, products and other things—may be computed.

While ratings for SCCs and SCC Host Entities may be more static in nature, e.g., statistics about a country, company, etc., deriving ratings for an object traversing a supply chain provides additional difficulties due to the fact that the object itself may, and often does, change as it traverses the sequential chain. For example, in embodiments—both of the SCR systems and methods and with those in interoperation with embodiments of rating—circumstances are likely to obtain in which instances of material (like a particular lot quantity of crude oil or agricultural raw material or the like) become comingled, e.g. in the admixing of one stream of such material with another stream. An example follows: In petroleum refining operations, it is common for multiple different crude oil streams to become admixed either before the streams reach a refinery site or at the site. Such admixing may be performed by an oil refiner in order to optimize a crude oil slate for charging into the distillation unit of the refinery. Now, 1) if one such stream of crude oil, by way of example, has traversed a sequential chain (like a supply chain) and thereby reached a refinery site via an SC that has may not be subject to track and trace operations by an SCR system, and 2) that crude oil stream becomes commingled with another stream that may be subject to track and trace operations by an SCR system, an apparent problem appears to arise. The problem is that just as the instances of material (the exemplary two crude oil streams) physically become commingled and mixed, in the example, so too do the data corresponding to the two streams become commingled and mixed. The problem, further then, becomes that—via such mixing of the data sets corresponding to the crude oil streams—the deeply-chained data that is enabled for the product stream that has been subject to track and trace operations of an SCR system becomes “diluted” by the corresponding data for the product stream that has not been subject to such operations enabled by an SCR system. Such situation may be expected in industry operations such as those of the oil and gas industry, although this nature of “data dilution” problem may over time wane as more and more enterprises and other entities participate in a particular SCR system. Nonetheless, not all value is lost for the deeply-chained data and information pertaining to the exemplary crude oil stream that has been a subject of an SCR system, even though it may appear an objective—that of enabling such deeply bound data to maintain unambiguous, inter-connected identity—may have been frustrated via the “mixing” event.

Under such circumstances as those just described, the embodiments disclosed herein may be adjusted to provide ratings that are qualified—for example, by probability estimates, statistical confidence-level values and the like—in such manner as to retain some useful aspects of such deeply bound data as enabled by an SCR system. An example of this follows: Assume that one lot of crude oil, which has been subject to track and trace operations of an SCR system (as described herein and in the prior referenced disclosures), is commingled with another such lot that has not been subject to such operations. Further, assume that the ratio (as proportions of the total, commingled resultant lot) of the commingled two lots of material is, say, 80:20, e.g., 80 percent of the first (“tracked”) lot is commingled with 20 percent of the second (“untracked”) lot. As such, the problem of mixing “tracked” data with “untracked” data may effectively be handled, for example, by assuming that first lot of crude oil is “tracked” and second lot is “untracked”.

With the exemplary relative weights of 80 and 20 percent for lots one and two, respectively, one of ordinary skill may readily comprehend that a system user or another may simply articulate, and definitively support, a fact such as: “The crude oil charged to this particular distillation unit in the refinery—while comprised of 80 percent Dahlia Light Crude Oil with a Rating of 3.39 and 20 percent of another crude oil with no Rating (because the latter, in the example, was assumed to be not subjected to operations of system compliant with the disclosed SCR systems herein)—in aggregate, has 80 percent probability, and not less, of having a Rating of 3.39 . . . .” In such manner, an analysis (e.g., statistical, Bayesian, average, median, etc.) may be used in order to retain information created from deeply-chained data that is enabled via the data binding operations of embodiments of rating that run in an SCR system.

As will be apparent to an artisan of ordinary skill, issues arise in tracking and tracing of materials, as materials (like oil, gas, agricultural raw materials, intermediate products produced from raw material resources, final consumer products and all nature of products, things, materials and the like) traverse sequential chains like supply and process chains. One consideration in this respect is that of how far-upstream materials (e.g. extracted resources like oil and gas), during traversal of sequential chains, typically change in their physical or chemical forms. For instance, crude petroleum oil typically is refined into refined petroleum products, whereby a refining process effectively destroys the original (farthest upstream) form of raw material by distilling, hydro-treating, catalytic cracking and other refining operations. In less common circumstances, and rarely today, crude oil may remain “whole” through its traversal of a sequential chain, e.g. as a quantity of crude oil may be transported to a power plant for “direct burning” in the electricity generation process and without refining operations being performed; clearly, in an instance of such direct burning of the raw material, the material itself is destroyed but not until the final stage of a sequential chain (e.g., excluding a hypothetical stage such as one treating with emissions created from such a direct burning process). As such, the ratings embodiments disclosed herein may be adjusted to compensate for changes in an object as it changes (e.g., physically) while traversing a sequential chain. While specific exemplary adjustments have been described herein, one of skill in the art will appreciate that any type of adjustment(s) may be performed without departing from the spirit of the disclosure. The disclosed systems and methods are contemplated in operating across many different systems and industries which have their own standard ratings formulas (and/or means of compensating for unknown information). In order to provide greater flexibility, the disclosed systems and methods are capable of receiving formulas, functions, or means of generating ratings from different industries, organizations, individuals, governments, etc. and applying the provided means to information in an OAR, or a sequential chain in general (e.g., a supply chain).

Generating Certifications

Certification of the source of a product, material, or service may be desirable in many situations. For example, sanction regimes may prevent countries from importing services or materials from a specific country. In other instances, the importation or use of materials may be prohibited due to government regulation, international agreement, or corporate decisions. Examples of such situations include, but are not limited to, bans on importing rare earth metals from certain countries, bans on purchasing conflict diamonds, decisions not to sell products produced in sweat shops, etc. However, in a global economy, materials may be exchanged between different entities many times before reaching their final destination. The number of transactions involved in transporting the materials obfuscates the original source of the material, thereby making certification that the material did not originate from (or was not handled by) a restricted entity very difficult.

The embodiments of the sequential chain constructs disclosed herein and in the related applications may be used to provide clarity as to the source and handlers of materials (or services) as they pass through a supply chain. Furthermore, the captured data related to an object as it traverses a sequential chain, such as a supply chain, can be analyzed against a set of rules to provide a certification that the object complies with a set of standards or regulations. In embodiments, the certification is referred to as a “ci-Certification.” A rules engine may be incorporated into the various systems disclosed herein. The rules engine may store different rules related to an object and the various entities that handle the object as the object traverses a sequential chain. These rules may be used to test the components of a constructed sequential chain to certify that the components comply with any restrictions (e.g., government regulations, sanctions, corporate decisions, etc.). One of skill in the art will appreciate that any type of rules engine known in the art may be employed with the embodiments disclosed herein.

In embodiments, the rules engine may store properties and/or criteria necessary to certify an object or sequential chain. The rules engine may store or otherwise access SC Properties, SCC Properties, SCC Host Entity Properties, Object/Product/material Properties, or any other type of properties, rules, and/or data that may be used to certify an object, a sequential chain, and/or a component of a sequential chain. The data may be stored or accessed from the various components that make up the supply chain data structure itself (e.g., an SC, an SCC, an SCC Host Entity, object, etc.) or from a standardized representation of the data that is stored in an OAR. In embodiments, a rules engine may comprise one or more databases storing rules, a software application that stores and selects rules, a combination of software and hardware operating on a single server or in a distributed environment, or any other type of rules engine. In embodiments, a sequential chain, and the components of the sequential chain, may be evaluated against the rules provided by the rules engine in order to provide a certification. In embodiments, the ci-Certification may be a binary value (e.g., true/false, pass/fail, etc.). In such embodiments, if the object, sequential chain, and/or its components pass the rules evaluation then the object, sequential chain, and/or sequential chain components may be certified (e.g., receive a positive certification, either with or without some kind of quantification of a qualitative notion of “positive certification”). Otherwise, if the object, sequential chain, and/or one or more of its components does not pass the rules evaluation, then no certification may be given (or a negative certification, either with or without some kind of quantification of a qualitative notion of “negative certification”). In other embodiments, the certification may not be a binary value (e.g., pass/fail). Rather, the ci-Certification may be a scaled ranking or score. For example, if most of the components comprising a sequential chain pass a rules evaluation, a weighted ci-Certification may be provided. In embodiments, the weighted ci-Certification may provide a measure of the confidence that the product, process, or material meets all of the rules. One of skill in the art will appreciate that the certifications provided herein may be applied to a variety of situations. In some situations, a binary ci-Certification may be returned (e.g., a product either comes from a sanctioned country or not). However, in other situations, it may not be necessary to fully comply with all rules in order still to receive certification. In such instances, a binary certification may still be provided; however, it may be beneficial to provide a weighted certification. By its nature, a weighted certification may contain additional information above a binary certification by, at the very least, providing information related to how close to complete certification the object, sequential chain, or sequential chain component is. One of skill in the art will appreciate that any type of weighting may be employed with the ci-Certification embodiments disclosed herein.

In embodiments, rules may be provided to a rules engine by one or more users interacting with an SCR system. In embodiments, the rules may be provided by an enterprise, a stakeholder, a government entity, a standards setting entity, or any other type of user or entity that has access to a sequential chain system as disclosed herein. In embodiments, the rules provided to the rules engine may be statically defined or may dynamically change over time. In addition, a user interface may be provided to allow a user of an SCR system to add, delete, and modify rules applicable to particular sequential chains or particular types of certifications. In further embodiments, the rules may be based upon ratings generated for one or more SCCs or the SC itself as previously described. For example, certification may be based upon a particular SCC (or the SC) attaining a specific ranking.

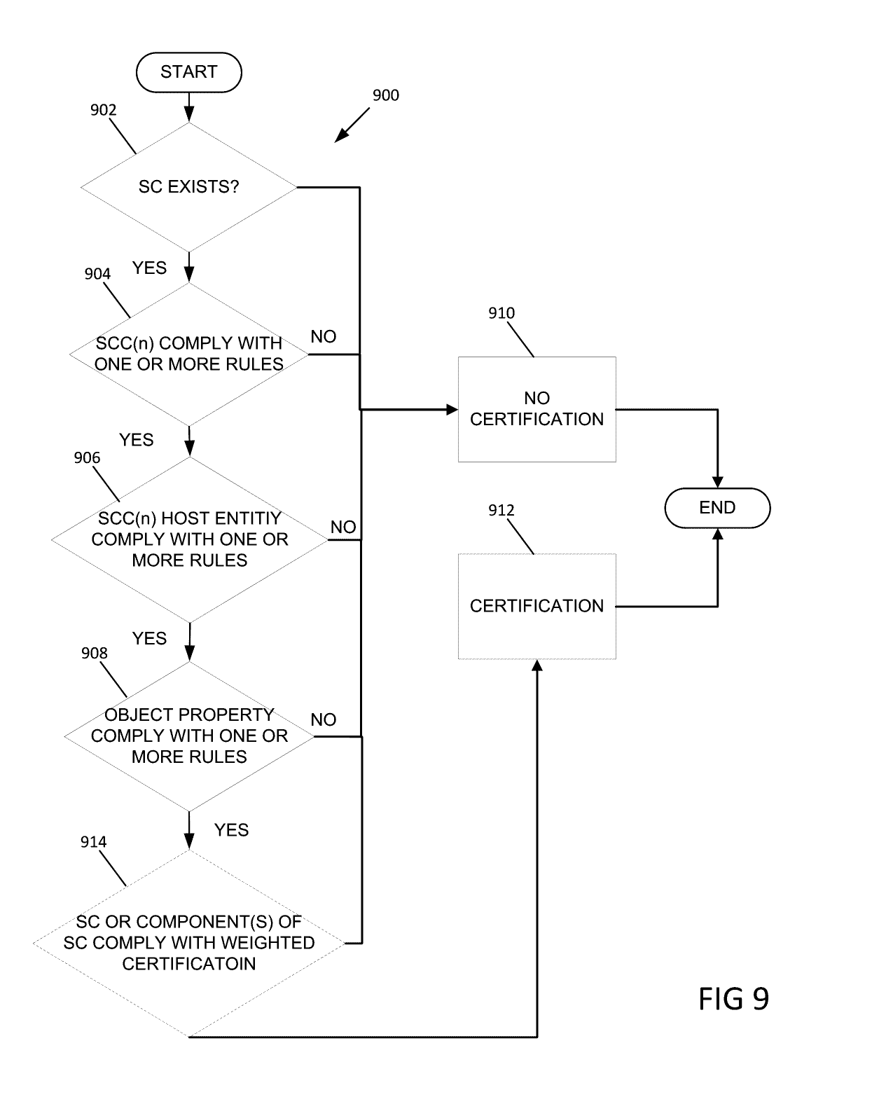

FIG. 9 is an embodiment of a method 900 for providing a certification for a sequential chain and/or various sequential chain components. Flow begins at operation 902, where a determination is made as to whether a sequential chain exists and within an SCR system performing the method 900. In embodiments, a valid sequential chain may be required or desired to provide certification. For example, if the certification relates to whether or not an object originated or was handled from a country currently under sanctions, the entire sequential chain of the object may be required to confirm that the sanctioned country had no interaction with the object. If a sequential chain does not exist, then flow branches NO to operation 910 and no certification is provided; such an outcome, for instance, may occur if a certification were sought by someone or some entity for a particular SC but no record of the particular SC was found to evidence that the SC had been registered as a registered SC in an SCR system. In embodiments, an indication may be provided at operation 910 to register the sequential chain. However, if a sequential chain exists and/or is registered with an SCR system or other system or computing device performing the method 900, then information related to the sequential chain is available to evaluate against rules. As such, flow branches YES to operation 904.

At operation 904, one or more rules are evaluated against one or more sequential chain components to determine whether or not the sequential chain component complies with the one or more rules. In embodiments, the one or more rules may be provided or accessed by a rules engine that may be part of the system performing the method 900. In embodiments, the one or more rules may specifically relate to different sequential chain components that form the sequential chain. In other embodiments, the one or more rules may be global rules that apply to all components of the sequential chain. The one or more rules related to SCCs may be evaluated against the one or more SCCs that make up the sequential chain. If one or more of the SCCs that make up the sequential chain fails the one or more rules at operation 904, then flow branches NO to operation 910, and no certification, therefore, is provided for the sequential chain. In other embodiments, failure of one or more SCC to meet a rule may not preclude certification. Rather, a threshold level of compliance with rules may be set (either predetermined or by receiving user input). In these embodiments, failure of a particular SCC to meet a rule is evaluated against the threshold to determine if the failure threshold for that sequential chain has been exceeded. If so, the flow branches to operation 910, and no certification is provided. If the SCCs comply with the one or more rules, then flow continues to operation 906. As used herein, complying with a set of rules includes reaching a level of compliance with the set of rules that does not preclude certification. Accordingly, compliance with a set of rules may include one or more individual rules being violated, so long as such individual violations do not preclude certification based on the failure threshold, weighted certification schema, or other definition of certification. Moreover, in embodiments where a weighted ci-Certification is provided regardless of how many SCCs fail to meet a rule, and if a weighted ci-Certification threshold is satisfied, then flow proceeds to operation 906.

At operation 906, one or more rules are evaluated against one or more sequential chain component host entities to determine whether or not the one or more SCC host entities comply with the one or more rules. In embodiments, the one or more rules may be provided or accessed by a rules engine that may be part of the system performing the method 900. In embodiments, the one or more rules may specifically relate to different sequential chain components that form the sequential chain. In other embodiments, the one or more rules may be global rules that apply to all components of the sequential chain. If the one or more SCC host entities do not comply with the rules, then flow branches NO to operation 910, and no certification is provided for the sequential chain. In other embodiments, failure of one or more SCC host entities to meet a rule may not preclude certification. Rather, a threshold level of compliance with rules may be set (either predetermined or by receiving user input). In these embodiments, failure of a particular SCC host entity to meet a rule is evaluated against the threshold to determine if the failure threshold for that sequential chain has been exceeded. If so, the flow branches to operation 910, and no certification is provided. If the one or more SCC host entities comply with the one or more rules, then flow continues to operation 908.

At operation 908, one or more rules are evaluated against one or more object properties, e.g., properties of an instance of material, to determine whether or not the one or more object properties comply with the one or more rules. In embodiments, the one or more rules may be provided or accessed by a rules engine that may be part of the system performing the method 900. In embodiments, the one or more rules may specifically relate to properties of objects that transit, or otherwise exist in, a particular component of the sequential chain. In other embodiments, the one or more rules may be global rules that apply to properties of objects that transit, or otherwise exist in, all components of the sequential chain. In still other embodiments, the one or more rules may relate to conjunctive conditions relating both to one or more properties of the object AND to one or more properties of an SCC or SCC Host Entity. An example of a conjunctive condition rule at operation 908, for instance, is a rule that tests for the country of origin property (as an SCC host entity property) AND for a property of the object as the object relates to the country of origin property. For instance, the conjunctive condition of “Iran” as an SCC host entity property AND of “crude oil” as an object property may result in rule non-compliance (e.g. if the rule is meant to test for crude oil originating in Iran, as a sanctioned country), whereas the conjunctive condition of “Iran” and “carpet” may result in rule compliance (e.g. if the rule is not meant to test for carpets originating in Iran). If the one or more object properties do not comply with the rules, then flow branches NO to operation 910 and no certification is provided for the sequential chain. In other embodiments, failure of one or more object property to meet a rule may not preclude certification. Rather, a threshold level of compliance with rules may be set (either predetermined or by receiving user input). In these embodiments, failure of a particular object property to meet a rule is evaluated against the threshold to determine if the failure threshold for that sequential chain has been exceeded. If so, the flow branches to operation 910, and no certification is provided. If the one or more object properties comply with the one or more rules, then flow continues to operation 912.

At operation 912, the sequential chain and the various components that make up the sequential chain, and in context of the object, thing, item or material in the sequential chain, have been evaluated against the one or more rules provided, for example, by a rules engine, and the evaluation resulted in a determination that the sequential chain (and its components) comply with the rules. As such, the sequential chain is certified at operation 912. In embodiments, the certification provides verification that a sequential chain complies with any rules that the object (e.g., material or product) traversing the sequential chain is subjected to. As such, the object may be certified with any applicable regulations, standards, etc., which regulations or standards need not necessarily be those articulated only by a formal body or entity but which also may be those articulated by a user, customer or another using an SCR system to articulate one's own such “personally-defined” regulations or standards.

As used herein, complying with a set of rules also comprises weighted certifications. For example, if one or more components do not comply with a rule used for evaluation, for example, does not meet a threshold requirement, fails a test defined by a function or computation, or otherwise is in non-compliance, an overall certification may still be granted to the supply chain if other components meet rule requirements. As such, overall thresholds may be applied during the certification process. For example, an overall threshold may allow certification when a certain number of components of the sequential chain meet compliance. The rule or set of rules (e.g., function, evaluation, comparison) defining a weighted certification may be evaluated at optional step 914 to determine if a condition exists in which certification may be granted to a SC even if not every component of an SC meets requirements for individual certification. In alternate embodiments not shown in FIG. 9, evaluation of components of the supply chain may continue upon failure of an individual component to determine whether a weighted certification may be granted rather than immediately declining certification upon failure of the individual component. In addition, weighted certification may also include defining certain rules to be more critical than others, whereby certification is weighted towards compliance with the relatively more important rules (or items being evaluated against such rules). Weighted certification can be used in combination with ratings such that a ratings score may be numerically weighted based on the relative importance of the rules (and items being evaluated under such rules), and wherein the certification depends on the final, weighted ratings score meeting a certain threshold.

The sequential chain embodiments provided herein allow for comprehensive evaluation of all the components related to the passage of an object through a sequential chain. As such, certification as to the origination and/or quality and/or other features of a product is both feasible and possible, despite the obfuscation that generally occurs as an object traverses a comprehensive, often trans-border, sequential chain. In embodiments, the certification provided at operation 912 (or lack of certification provided at operation 910) may be a binary value. For example, the sequential chain, an object traversing (or having traversed) it, and the various components of the sequential chain are either certified or not. In other embodiments, however, the certification provided at operation 912 may be a scaled value. In embodiments, the scaled value may indicate additional information such as the degree as to which an object may be certified.

Although the method 900 is illustrated as comprising a number of discrete steps performed in a particular order, one of skill in the art will appreciate that the operations of method 900 may be performed in a different order without departing from the scope of this disclosure. Furthermore, fewer or additional steps may be performed as part of the method 900. One of skill in the art will appreciate that the method 900 may be modified without departing from the spirit of the embodiment. For example, the evaluations performed at operations 902, 904, 906 and 908 may be performed in different order, such as, but not limited to, by evaluating the object properties against the rules first. Additionally, in alternate embodiments, it may not be necessary to evaluate rules against all SCCs, all SCC host entities, and all object properties in relation: to each other; to the SC itself, and/or to any combination of these elements. For example, in some embodiments, information related to one of the specific components may not be present (e.g., SCC host entity data may not exist). Similarly, one or more rules may not relate to specific components of the chain. In such embodiments, if no rules relate to SCC host entities (or to any other sequential chain component), there may be no requirement to evaluate a specific type of component in method 900. As one of skill in the art understands, the embodiments of sequential chain constructs described herein and in related applications are applicable to many different situations related to an object, or in other situations and events, that transit (or, occur in, in respect of events) a sequential chain. As such, sequential chains may be used in a variety of different situations in which any number of different rules may be provided and/or stored by a rules engine and subsequently applied in the method 900. As will be apparent to one of skill in the art, many different logical constructions of rules may be employed in embodiments: i) using logical operators such as AND, OR, NOT and other operators, and ii) employing properties relating to some or all of SCC, SCC host entity and object.

Insofar as the applicant has already filed patent applications for both Sequential Chain Registry artifacts and Event Chain Registry artifacts, the descriptions herein of embodiments of Chain Integrity and Chain and Product Certification are intended to apply to any or all of those artifacts, e.g., to SCR systems operating in any of the various modalities set out in the prior referenced applications. In such manner, then, any nature of Property relative to any “object,” “thing,” or “event” in, or occurring in, a sequential chain may be a candidate for including as a metric in an embodiment of ratings and/or certification.

In embodiments, the data accessed and evaluated as a part of the method 900 may be data that is extracted from components such as an SC, an SCC, an SCC Host Entity, or an object. In embodiments, such object may be accessed at the time the method 900 is performed. However, in other embodiments, one or more OARs may be generated prior to, or in response to, the execution of the method 900. The one or more OARs may contain data from the sequential chain.

Exemplary Embodiments Providing Interoperation Between Object Analytical Records (OARs) and External Systems

In embodiments, the construction of sequential chains provides a unique way to capture information related to an object, such as a product or thing, as it traverses a supply chain or may be related to a sequence of events that occur over time. In embodiments, the data collected as part of a sequential chain, including data that may be part of an SCC or SCC Host Entity, object, or any other component of a sequential chain may be digitally stored, for example, in a database. Furthermore, as described in the prior referenced applications, the data collected as part of the sequential chain may be incorporated into an Object Analytical Record (OAR). In embodiments, an OAR is not limited to storing information about a particular object. Instead, an OAR may be used for any type of informational objective, that is, may be used to store any type of data for any purpose. For example, information from a sequential chain may be aggregated into a data file or files (within a database). In embodiments, an OAR may contain information related to the traversal of a supply chain by a product or thing, by a component of a supply chain, by the performance of a particular event in an event sequence, or any other type of information that may be captured using the sequential chain constructs disclosed herein and in the prior referenced applications.

In embodiments, an OAR may be used to construct a data record related to an object or item as it traverses a sequential chain (e.g., an Item-OAR), a data record related to an event (e.g., an Event-OAR), or any other type of object or objective. In embodiments, one or more OARs may be constructed to represent any type of data, object, item, or event represented by data captured in one or more supply chain constructs (e.g., an SC, and SCC, and SCC Host Entity, etc.). As such, in embodiments, an OAR may be a data set that includes data obtained by extracting data, which otherwise often lies hidden or obscured in non-communicating multiple different supply chain management (SCM) systems, from enterprise and cross-enterprise sequential chains (e.g., supply chains, event chains, etc.).

In embodiments, the OAR may be utilized to capture and bind data related to a sequential chain, such as, but not limited to, a supply chain, process chain, event chain or other nature of value chain employed in many or most sectors and functions of the global economy. For example, the sequential chain registry may be used to capture and bind data related to an event, or set of events, over a sequence or time or a product traversing a sequential chain. The data may be captured and bound using the various sequential chain components disclosed herein and in the prior referenced applications. For example, an SCR system may employ Vertical Logical Conjunction to enable the capture of information when and where the data exists in a component of a sequential chain. This data may be part of a real-world economy network (e.g., a supply chain) or another type of network. It could even be data about multi-step processes involved in less tangible endeavors in the economy, such as a complex set of human interactions mutually engaged over years of time in negotiating something as complex as a trans-border hydrocarbons pipeline, like the BTC oil pipeline originating in Azerbaijan, and requiring hundreds of cross-referenced and inter-linked agreements and contracts with complex event-triggers and mutual obligations amongst multiple different commercial entities and different nations, where such triggers and obligations may have a forward lifespan of decades' time. Horizontal Logical Conjunction may then be employed to bind the information through time and space for supply chain components that are part of the supply chain. As such, the embodiments of SCR systems and methods disclosed herein may be used to capture and bind data from a network. Such data may be stored in one or more OARs. Furthermore, in embodiments, the OARs may be filtered according to search terms representing properties, text, or any other type of data stored in a sequential chain. As such, OARs may be used to efficiently access captured and bound data for any type of network represented by a sequential chain. Another promising area of application of embodiments, including with OARs, and in the domain of intangible value chains, may be with respect to the patent application process itself. Another such example, also in the domain of intangible-type objects and/or processes, may be in that of linking together complex sets of inter-leaved medical records, diagnoses, procedures and the like regarding human health services. Another may be with respect to security and crime prevention (and detection) opportunities, including national and homeland security, where actual sequences of events may hold significant clues for detecting hidden patterns, leading to improved or less dangerous outcomes. In these and many other areas wherein temporal and/or spatial sequencing of data and information may hold value, the construct of OARs, used in conjunction with embodiments as herein described and as described in prior referenced disclosures, may afford significant value in numerous aspects of the modern economy and the societies dependent upon the economy.

In further embodiments, the data stored in an SCR system, which may represent a real-economy network (e.g., supply chains), may be aggregated with social network data to provide enhanced prediction capabilities. For example, predictions related to demands in the real-economy network may be enhanced by combining information from an SCR network and a social network. In embodiments, one or more OARs may be leveraged to aggregate information between the networks.

In still further embodiments, OARs may provide the ability to integrate SCR sequential chain data with other systems, such as search engines, recommender systems and algorithms, public networks, private networks, or any other type of network storing information, including but not limited to, for instance, systems operated via semantic web services.

As will also be apparent to an artisan of ordinary skill, computation performed in connection with embodiments used in creating OARs is performed in a computational environment, which is next described.

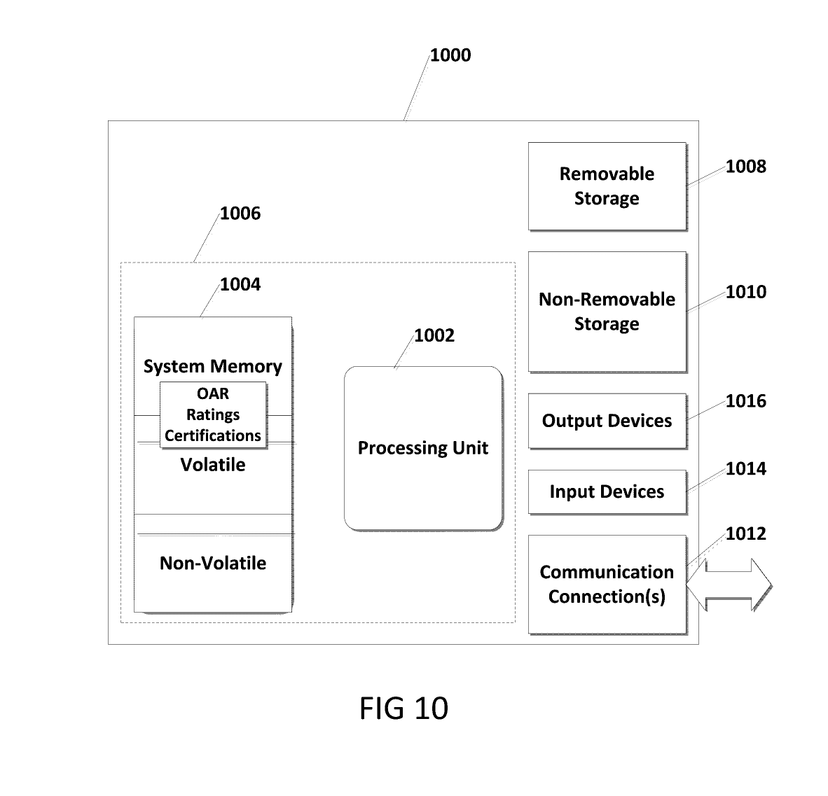

FIG. 10 and the additional discussion in the present specification are intended to provide a brief general description of a suitable computing environment in which the present disclosure and/or portions thereof may be implemented. Although not required, the embodiments described herein may be implemented as computer-executable instructions, such as by program modules, being executed by a computer, such as a client workstation or a server, including a server operating in a cloud environment. Generally, program modules include routines, programs, objects, components, data structures and the like that perform particular tasks or implement particular abstract data types. Moreover, it should be appreciated that the disclosure and/or portions thereof may be practiced with other computer system configurations, including hand-held devices, multi-processor systems, microprocessor-based or programmable consumer electronics, network PCs, minicomputers, mainframe computers and the like. The disclosure may also be practiced in distributed computing environments where tasks are performed by remote processing devices that are linked through a communications network. In a distributed computing environment, program modules may be located in both local and remote memory storage devices.

FIG. 10 illustrates one example of a suitable operating environment 1000 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, operating environment 1000 typically includes at least one processing unit 1002 and memory 1004. Depending on the exact configuration and type of computing device, memory 1004 (storing, among other things, sequential chains constructed as described herein) may be volatile (such as RAM), non-volatile (such as ROM, flash memory, etc.), or some combination of the two. Memory 1004 may store computer instructions related to generating the OAR and perform the OAR methods disclosed herein. Memory 1004 may also store computer-executable instructions that may be executed by the processing unit 1002 to perform the methods disclosed herein.

This most basic configuration is illustrated in FIG. 10 by dashed line 1006. Further, environment 1000 may also include storage devices (removable, 1008, and/or non-removable, 1010) including, but not limited to, magnetic or optical disks or tape. Similarly, environment 1000 may also have input device(s) 1014 such as keyboard, mouse, pen, voice input, etc. and/or output device(s) 1016 such as a display, speakers, printer, etc. Also included in the environment may be one or more communication connections, 1012, such as LAN, WAN, point to point, etc.

Operating environment 1000 typically includes at least some form of computer readable media. Computer readable media can be any available media that can be accessed by processing unit 1002 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 1000 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

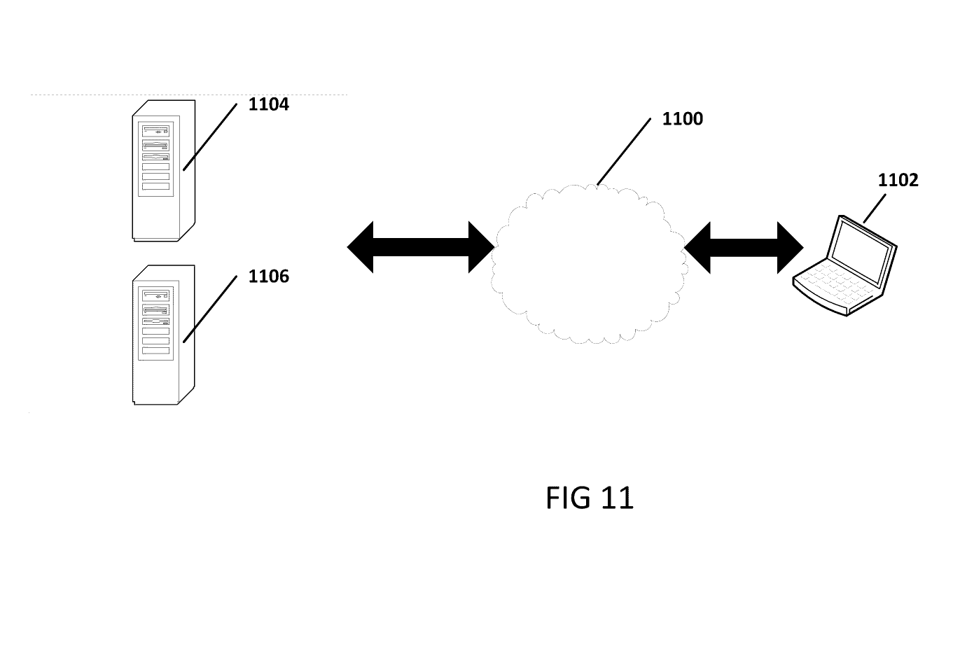

FIG. 11 is an embodiment of a network 1100 in which the various systems and methods disclosed herein may operate. In embodiments, a client device, such as client device 1102, may communicate with one or more servers, such as servers 1104 and 1106, via a network 1108. In embodiments, a client device may be a laptop, a personal computer, a smart phone, a PDA, a netbook, or any other type of computing device, such as the computing device in FIG. 10. In embodiments, servers 1104 and 1106 may be any type of computing device, such as the computing device illustrated in FIG. 10. Network 1108 may be any type of network capable of facilitating communications between the client device and one or more servers 1104 and 1106. Examples of such networks include, but are not limited to, LANs, WANs, cellular networks, and/or the Internet.

In embodiments, the various systems and methods disclosed herein may be performed by one or more server devices. For example, in one embodiment, a single server, such as server 1104 may be employed to perform the systems and methods disclosed herein. Client device 1102 may interact with server 1104 via network 1108 in order to access information such as, information about a supply chain, an OAR, or any other object, property, and/or functionality disclosed herein. In further embodiments, the client device 1106 may also perform functionality disclosed herein, such as by displaying one of the disclosed forms and collecting information from a user.

In alternate embodiments, the methods and systems disclosed herein may be performed using a distributed computing network, or a cloud network. In such embodiments, the methods and systems disclosed herein may be performed by two or more servers, such as servers 1104 and 1106. Although a particular network embodiment is disclosed herein, one of skill in the art will appreciate that the systems and methods disclosed herein may be performed using other types of networks and/or network configurations.

Although specific embodiments were described herein and specific examples were provided, the scope of the disclosure is not limited to those specific embodiments and examples. One skilled in the art will recognize other embodiments or improvements that are within the scope and spirit of the present disclosure. Therefore, the specific structure, acts, or media are disclosed only as illustrative embodiments. The scope of the disclosure is defined by the following claims and any equivalents therein.

What is claimed is:

1. A method of performing analytics on at least one sequential chain, the method comprising:
receiving data from the at least one sequential chain;
constructing an Object Analytical Record (OAR) using the data from the at least one sequential chain, wherein the OAR comprises information about at least one sequential chain component, wherein constructing the OAR comprises standardizing data from the at least one sequential chain component;
receiving a request to perform analytics on the at one sequential chain; and
in response to receiving the request, performing the analytics using data from the OAR.

2. The method of claim 1, wherein the OAR further comprises data about at least one sequential chain component host entity.

3. The method of claim 1, wherein receiving data from the at least one sequential chain comprises receiving all data from the at least one sequential chain.

4. The method of claim 1, wherein receiving data from the at least one sequential chain comprises receiving a subset of data from the at least one sequential chain.

5. The method of claim 1, wherein the OAR is constructed as the at least one sequential chain is created.

6. The method of claim 1, wherein the OAR is constructed in response to the request to perform analytics on the at least one sequential chain.

7. The method of claim 1, wherein performing the analytics further comprises determining a rating for the at least one sequential chain.

8. The method of claim 7, wherein determining the rating is based upon a ratings function specifying at least one metric by which to rate the at least one sequential chain.

9. The method of claim 8, wherein performing the analytics further comprises determining at least one rating for at least one sequential chain component of the at least one sequential chain.

10. The method of claim 1, wherein performing the analytics further comprises determining a certification for the at least one sequential chain.

11. The method of claim 10, wherein determining a certification further comprises:
evaluating the sequential chain against a set of rules, wherein evaluating the sequential chain against a set of rules further comprises at least one of:
evaluating at least one sequential chain component against the set of rules;
evaluating at least one sequential chain host entity against the set of rules; and
evaluating at least one object property against the first set of rules.

12. The method of claim 11, further comprising, based upon the valuation of the sequential chain, providing a certification.

13. A computer storage medium encoding computer executable instructions that, when executed by at least one processor, perform a method for performing analytics on at least one sequential chain, the method comprising:
receiving data from the at least one sequential chain, wherein the data comprises data about at least one of a sequential chain component, a sequential chain host entity, and an object property;
constructing an Object Analytical Record (OAR) using the data from the at least one sequential chain, wherein constructing the OAR comprises standardizing data from the at least one sequential chain component;
receiving a request to perform analytics on the at one sequential chain; and
in response to receiving the request, performing the analytics using data from the OAR.

14. The computer storage medium of claim 13, wherein performing the analytics further comprises determining a rating for the at least one sequential chain.

15. The computer storage medium of claim 14, wherein determining the rating is based upon a ratings function specifying at least one metric by which to rate the at least one sequential chain.

16. The computer storage medium of claim 14, wherein performing the analytics further comprises determining a rating for a subset of the at least one sequential chain.

17. The computer storage medium of claim 13, wherein performing the analytics further comprises determining a certification for the at least one sequential chain, wherein determining a certification further comprises:
evaluating the sequential chain against a set of rules, wherein evaluating the sequential chain against a set of rules further comprises at least one of:
evaluating at least one sequential chain component against the set of rules;
evaluating at least one sequential chain host entity against the set of rules; and
evaluating at least one object property against the first set of rules.

18. A system for performing certification on at least one sequential chain, the system comprising:
at least one processor; and
at least one computer storage medium in communication with the at least one processor, the at least one computer storage medium encoding computer executable instructions that, when executed by at least one processor, perform a method for certifying at least one sequential chain, the method comprising:
receiving data from the at least one sequential chain, wherein the data comprises data about at least one of a sequential chain component, a sequential chain host entity, and an object property;
constructing an Object Analytical Record (OAR) using the data from the at least one sequential chain, wherein the OAR comprises information about at least one sequential chain component;
evaluating at least one sequential chain component against a first set of rules, wherein data for the at least one sequential chain component is stored in the OAR; and
when the at least one sequential chain component complies with the first set of rules, providing a certification.

19. The system of claim 18, further comprising:
when the at least one sequential chain component does not comply with the first set of rules, evaluating at least one sequential chain host entity against a second set of rules, wherein data for the at least one sequential chain host entity is stored in the OAR;
when the at least one sequential chain host entity complies with the second set of rules, when the at least one object property complies with the second set of rules, determining a weighted certification; and
based upon the determination, providing a certification.

20. The system of claim 18, wherein providing the certification comprises providing a graphical output of the certification.
